(19) United States
(12) Patent Application Publication
(10) Pub. No.: US 2013/0047655 A1
(43) Pub. Date: Feb. 28, 2013

(54) ATMOSPHERIC WATER GENERATOR

(71) Applicant: Keith White, Mission (CA)

(72) Inventor: Keith White, Mission (CA)

(73) Assignee: AWG International, Inc., Bellingham, WA (US)

(21) Appl. No.: 13/510,757

(22) PCT Filed: Nov. 19, 2010
(86) PCT No.: PCT/US10/57371

§ 371 Date: Nov. 12, 2012

Related U.S. Application Data
(60) Provisional application No. 61/262,862, filed on Nov. 19, 2009.

(51) Int. Cl. C02F 1/78; F25D 27/00; F25D 21/14

(52) U.S. Cl. 62/264; 62/291

(57) ABSTRACT

An atmospheric water generator and system for condensing and collecting moisture contained in the air serves to cool and dehumidify the air. The collected water is purified and can be dispensed at hot or cold temperatures, on demand. In alternative embodiments, the system can be used in a multi-zone application or to provide cooled air and water to a building. An embodiment primarily for use as an air conditioning unit is also described.

### BACKGROUND

1. Technical Field

The present disclosure relates to systems for producing potable water from air and, more particularly, to atmospheric water generators that sterilize, store, and dispense water collected from the atmosphere.

2. Description of the Related Art

Atmospheric water generators are used to provide water to areas that do not otherwise have sufficient natural water resources to provide for the needs of human residents, animals and plants.

In a series of applications (U.S. Pat. No. 7,272,947, U.S. Pub. Nos. 2008/0022694 and 2009/0077992, each of which is hereby incorporated by reference), Anderson and White describe a water producing system adapted to condense water from the air and collect it in a storage tank. Condensed water drips down into a collection tray, and then passes through a conduit into a main storage tank. Ozone gas is bubbled or injected the main tank to kill any bacteria. The main drawbacks to this system are the need to remove the ozone from the water in order to render it potable and the need to use ozone-resistant materials for the tank and associated fittings, which can increase the cost of the system. Further, excess ozone must be vented in order to avoid an increased pressure within the main tank. However, as airborne ozone is an irritant, inhalation of which can worsen asthma and cause coughing, wheezing, throat irritation and chest pains, there is a need for an additional filtering system to convert the ozone gas into oxygen gas before it can be vented into the atmosphere. In addition, the system shown does not explicitly deal with the need to filter organic matter, from which endotoxins can form within the tank. Finally, the carbon filters in the system can be very difficult to maintain, as the filtering process can lead to coalescence of the carbon filtration material, blocking the filter.

### BRIEF SUMMARY

The present disclosure provides for an atmospheric water generator and system that overcomes the foregoing deficiencies.

In accordance with one aspect of the present disclosure, an atmospheric water generator is provided that draws moisture-laden air into a tank, cools it to condense out the moisture, and vents the dry air back into the atmosphere. The condensed water is collected in a lower portion of the tank, then is pumped out of the tank and purified before being returned to the tank, thereby keeping the collected water from becoming stagnant. The purification system can include an external ozone injection, followed by appropriate processes to remove the ozone and other impurities. Alternatively, the process can include various other methods of purifying the water. The process may also include internal water circulation circuits, which keep impurities from building up at several points within the tank.

In accordance with another aspect of the present disclosure, an atmospheric water generator is described, which provides purified water at hot or cold temperatures, ideally on demand, meaning the water is not heated or cooled until dispensing. The system may include internal circuits that can provide the energy necessary to heat or cool the water before dispensing, providing a system that is self-contained, easy to maintain, and efficient.

In accordance with a further aspect of the present disclosure, the atmospheric water generator can be used on an industrial scale to provide heating, dehumidification, air conditioning, and clean water to an area, such as a house, with multiple zones, or on a larger scale, such as in an apartment building with several units.

In accordance with still yet another aspect of the present disclosure, an atmospheric water generator is disclosed that can be used as an air conditioning unit.

The foregoing is intended as a broad summary only and of only some of the aspects of the disclosure. Other aspects of the disclosure will be more fully appreciated by reference to the detailed description of the preferred embodiment. Moreover, despite this disclosure, the actual disclosure, inventive apparatus, methods, concepts and inventive ideas for which this patent is sought are ultimately defined only by the formal claims of this application, not by the details of the summary or of the preferred embodiment.

### BRIEF DESCRIPTION OF THE SEVERAL VIEWS OF THE DRAWING(S)

The foregoing and other features and advantages of the present disclosure will be more readily appreciated as the same become better understood from the following detailed description when taken in conjunction with the accompanying drawings, where:

FIG. 1 is a schematic of an atmospheric water generator according to one embodiment of the disclosure;

FIG. 2 is a schematic of an atmospheric water generator according to another embodiment of the disclosure;

FIGS. 3A and 3B are schematics of atmospheric water generators according to further embodiments of the disclosure;

FIG. 4 is a schematic of an atmospheric water generation, heating, dehumidification and air conditioning system according to an embodiment of the disclosure;

FIG. 5 is a schematic of a multi-room atmospheric water generation, heating, dehumidification and air conditioning system according to an embodiment of the disclosure; and

FIG. 6 is a schematic of an air conditioning system using an atmospheric water generator according to an embodiment of the disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with projection systems, including but not limited to power supplies, controllers, and related software have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Heat pump/refrigeration cycles are well understood in thermodynamic disciplines and generally include a condenser, an expander, an evaporator, a compressor and a refrigerant fluid. Some basic background information on the heat pump cycle is provided herein. The condenser and expanders are generally heat exchangers in some form which comprise elongated tubes structure in a manner to maximize the exposed surface area. The heat pump forms a close-loop circuit where the refrigerant fluid constantly heats up and cools down at various portions within the elongated tubes. As the refrigerant fluid exits a compressor, the pressure of the compressing fluid is increased substantially pursuant to the natural gas law of PV=nRT, resulting in a temperature increase in the fluid. The compressor is in communication with the condenser and the exiting hot refrigerant fluid, which is warmer than the ambient conditions, will cool down and condense to a liquid within the close looped system. Therefore, the refrigerant, which is now under high pressure and in liquid form within the condenser, passes to an expander, which is in fluid form and interposed between the evaporator and the condenser tubing or coils.

The expander in general is an orifice type restrictor that maintains a pressure drop from the upstream side (near the condenser) to the downstream side (near the evaporator). The expander allows for a higher pressure within the condenser and when the refrigerant passes there through, the expansion of the refrigerant provides for immediate cooling which lowers the temperature of the evaporator. Therefore, the cool refrigerant, which is at a temperature below ambient conditions, draws heat from adjacent ambient air. Because the refrigerant has expanded to lower pressure, pursuant to the natural gas law of PV=nRT (or one of the equivalent natural gas equations) the temperature drops commensurately with the drop of the pressure to balance this equation. The drop in temperature is conducted through the outer surface of the evaporator coil and this heat gradient with the ambient temperature draws heat thereto. Depending upon the location within the close-loop stream in the evaporator, the refrigerant having a rather low boiling point will evaporate therein drawing heat from the ambient conditions. Thereafter, the gaseous refrigerant passes to the compressor where it is re-compressed and the closed looped circuit continues.

What follows next is a description of one embodiment of a device and system to extract, purify and deliver water. It should be noted that described throughout there are various combinations for executing various functions of the water producing device. For example, there is a plurality of ways of cooling the water condensate member or coils. Further, various methods of purifying the water are described, many of which can be used in conjunction with the various methods of condensing and obtaining the water. Therefore, it should be appreciated that various combinations of elements can be combined for a wide variety of embodiments which are greater than the number of figures disclosed herein. Further, various optional components such as hot and cold water tanks can be incorporated.

In the embodiments described herein, like elements are depicted with identical reference numbers.

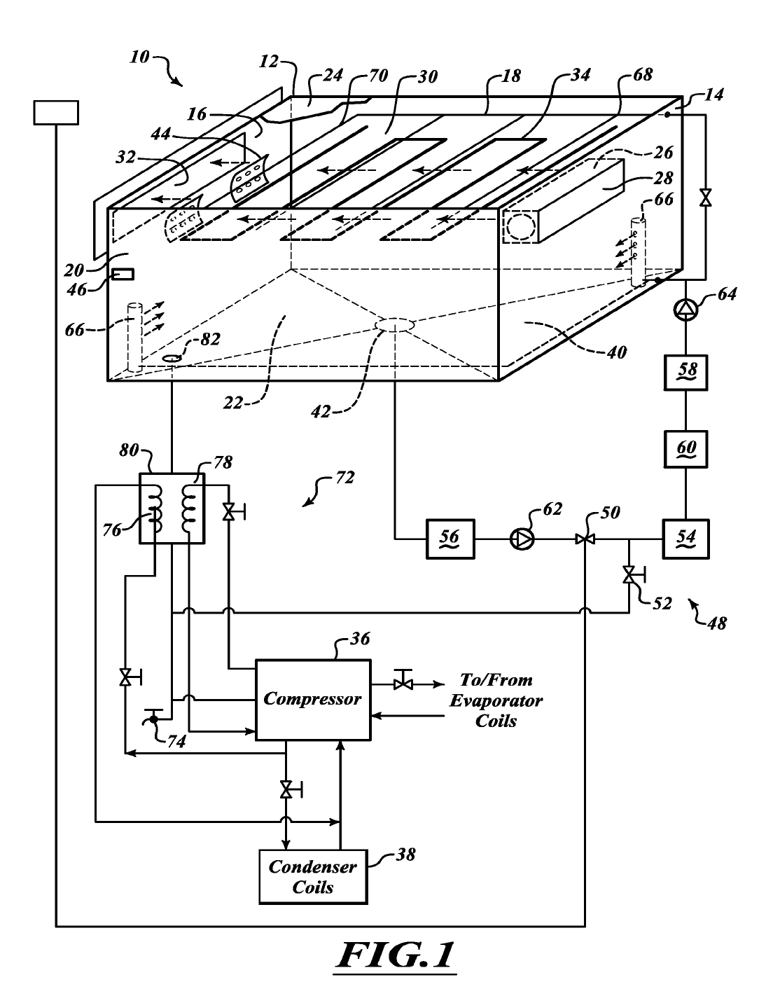

FIG. 1 shows a first embodiment of an atmospheric water generator 10 according to the disclosure. The generator 10 includes a tank 12 having a front wall 14, back wall 16, first and second side walls 18, 20, a bottom wall 22, and a top wall 24 (shown in partial cutaway for purposes of illustration). A fan 26, preferably positioned in an interior of the tank 12 and ducted to minimize noise and act as a muffler system as well as maintains a positive pressure in the tank, pulls air (shown with dashed arrows) through an inlet 28 from the surrounding area, such as a room, into a water condensation portion 30 of the generator tank 12, and the air then exits the tank 12 through an outlet opening 32. The fan 26 may also serve as a primary air filter. The air passes across one or more water condensing members or evaporator coils 34, which are preferably evaporation coils coated with titanium oxide, or stainless steel, or any other appropriate material, which should be of a food grade coating or a coating that would not allow the leaching of aluminum into the water and fir for potable applications. Moisture in the air condenses on the evaporator coils 34, from where it then drips down onto the bottom wall 22 and accumulates in the tank 12.

The evaporator coils 34 are in fluid communication with a compressor 36 that is also in fluid communication with condensing coils 38. The compressor 36 compresses a refrigerant fluid through the condensing coils 38 to condense the operating refrigerant fluid/gas, which generates heat. The air around the condensing coils 38 is cooled via conventional means. The fluid passes from the condensing coils 38 to the water condensing coils 34 where the water condenses on the outer surface.

In the present design, the evaporator or water condenser coils 34 are ideally covered with a food grade coating. This may include, without limitation, stainless steel or titanium oxide, for example, and other commercially available coatings that can be applied by spraying, dipping, and other known methods. Ideally, the coating provides for corrosion resistance without inhibiting the condensation of water for potable applications, e.g., meets U.S. Department of Agriculture requirements for contact surfaces.

The water condensing members or coils 34 may be finned, to provide more surface area with which to condense water from the air. The cooled air, which has been divested of much of its moisture, is then vented out of the generator tank 12 back into the atmosphere through a suitable outlet 32 while the collected water moves into the collection portion 40 of the generator tank 12. Ideally the bottom wall 22 is structured to direct the water to a central collection point 42 that is the lowest point in the tank 12.

The water condensing members or coils 34 are cooled with any suitable refrigerant moved through by the compressor 36, which is preferably a variable speed compressor, but which may be any suitable compressor, such as a rotary or reciprocating compressor. The refrigerant passes through the condenser coils 36 to remove heat before returning to the compressor. If it is preferable not to vent cooled air, one or more condensing coils 38, which form part of the heat pump cycle including the water condensing members or evaporator coils 34 and the compressor 36, may be placed near the outlet of the generator tank, in order to heat the air as it is vented back into the room.

The water condensing portion 30 of the system may further comprise a diverter 44, consisting of one or more perforated sheets of suitable material, such as plastic or stainless steel plates. The diverter 44 is located across the condensing member from the fan and adjacent the exit opening 32, and it serves to divert a portion of the air back into the system for another pass across the evaporator coils, thereby increasing the efficiency of the water condensation system. The perforated sheets may be of any suitable shape, such as flat or curved, and orientation, such as perpendicular or angled relative to the airflow direction, to divert a suitable proportion of the air brought in by the fan back across the condensing member.

A sensor 46 may be placed in the generator tank to indicate when the collected water level is becoming too high.

From the collection portion 42 of the generator tank 12, the condensed water moves through a purification system 48. In the embodiment shown in FIG. 1, the purification system 48 is an external circuit, in which ozone may be injected into the water via an ozone injector 50, killing any bacteria and other impurities in the water as it passes the injection area. The ozone may then immediately be purged from the purification circuit 48. A valve 52 is gravity fed from the heating-cooling unit 80 to form a circulation loop from the tank 80 back into the purification circuit 48. If the spigot 74 was not in use for a extended period, the would be no water flow in the dispensing loop and it would in effect become a dead leg and could grow bacteria. It should also be noted that 52 can connect either upstream of 50 or down stream as shown in FIG. 1. The water continues through a purification chamber 54, where it may be further treated by any suitable means, such as an ion exchange, LED, titanium oxide, ultraviolet or carbon filter, or any combination of the foregoing. The external application of the ozone gas, combined with the relatively immediate removal of the injected ozone, minimizes the portion of the generator system that must be composed of ozone-resistant material, as well as requiring low amounts of ozone and preventing any large pressure buildup in the system. In the alternative, the ozone injection portion of the purification system may be omitted, and the water can simply be purified in the purification chamber, by any suitable means, such as ion exchange, LED, titanium oxide, ultraviolet or carbon filtration or any combination of the foregoing. The purification system can include an optional pre-filter 56 positioned upstream from the ozone injector 50, as well as hot and cold dispensers 58, 60. A conventional pump 62 draws the water into the purification system 48 and an optional second pump 64 can be used to push the water back into the tank through at least one stand pipe 66, and preferably two stand pipes 66 located in opposing corners of the tank 12 that direct the water to flow in the tank 12, ideally in a circular fashion, such as clockwise or counterclockwise. The movement of the water prevents stagnation and the build-up of impurities as well as scrubs surfaces on the interior of the tank that are in contact with the water, such as the bottom wall 22, and portions of the front wall 14, rear wall 16, and side walls 18 and 20. Ideally, the stand pipes 66 are jetted or contain nozzles to provide more force and directional movement of the filtered water as it exits the stand pipe 66.

The purified water can be dispensed through a dispensing portion 72 of the system as required through a spigot 74, while any excess water may return to the lower portion of the generator tank 12. The pressure and direction of the purified water return is such as to cause the water to move about the inner perimeter of the generator tank, such as the jetted pipes 66 described above, which scrubs down the sides of the tank, preventing buildup of organic or other undesirable matter, particularly at or near the waterline. The pipes 66 need not be jetted and can merely be openings in the pipes 66 directionally oriented to provide the desired direction of water movement in the tank 12.

Another optional feature is the coil clean system 68 that conducts water through pipes 70 located over the evaporator coils 34 controlled by a suitable valve and manual or automatic control system to dispense water on to the coils 34 to clean the coils 34, as well as aid in cooling the coils 34 as well as acting to defrost the coils 34 in the event of ice build up on the coils 34. At least a portion of the purified water is thus diverted to periodically flow over and rinse the evaporator coils 34 and diverter 44, thereby minimizing any dirt or scale buildup in the upper portion of the generator tank.

The dispensing portion 72 of the system may include means by which the water temperature can be adjusted as required by the user. For example, a heating coil 76, which may be electric or which may be heated by hot gas from the compressor 36 or by any other suitable method, may heat the water as it passes through the dispensing portion of the generator system. In the alternative, any similar rapid, preferably direct-contact, heating method may also be used. In addition, or in the alternative, if hot water is not required for a specific application, a cooling coil 78, which again may be electric, or which may be cooled by the compressor or by any other suitable cooling method, may cool the water as it passes through the dispensing portion of the generator system. One or both coils 76, 78 can be housed in a heating-cooling unit 80 in fluid communication with a dispensing outlet 82 in the bottom wall 22 of the tank 12.

Ideally, the heating coil 76 is electric, about 500 Watts, and provides fast heat with no more than a 4 to 5 second delay. Similarly, the cooling coil 78 may be electric or be coupled to the evaporator coil for maximum of 3-second delay in chilling the water.

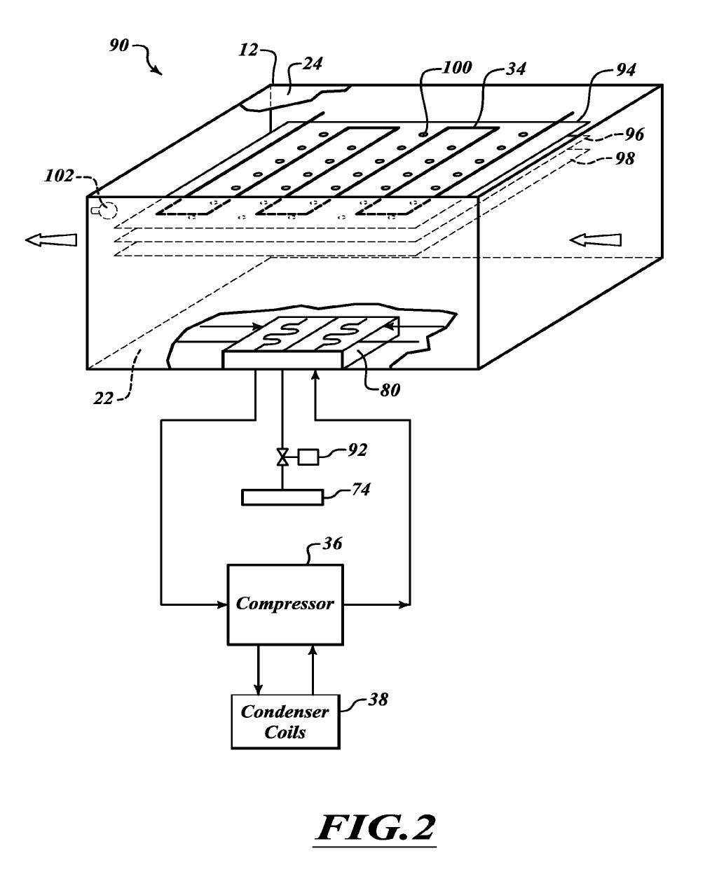

In alternate embodiments, the water generation system 90 shown in FIG. 2 has the heating-cooling unit 80 moved to the interior of the tank 12, such as on the interior side of the bottom wall 22. Water is dispensed to the spigot 74 through a solenoid valve 92. In addition, a purification mechanism or mechanisms formed of one or more titanium oxide plates 94, 96, 98, are positioned under the evaporator coils 34 to collect the water that falls from the coils 34. In this way, an ozone-free water generation system is provided. In one embodiment, the top plate 94 is coated with titanium oxide food grade coating and include holes or openings 100 to allow water to flow there through. The intermediate plate 96 can be a sediment filter while the bottom filter 98 can be a carbon filter element. An optional pump can be used in the tank 12 to circulate water. Other parts of the system, such as the evaporation portion, are similar to those shown in FIG. 1. This embodiment eliminates all use of ozone.

As in the embodiment shown in FIG. 2, all or part of the dispensing portion 72 of the system 90 can be located within a generator tank housing that includes the tank 12. Heating and/or cooling coils as discussed above may be located within a chamber 80 within the tank 12, and the collected water passes through the chamber 80 to be heated or cooled before being dispensed. An optional light 102, such as an LED, is provided for purification as desired.

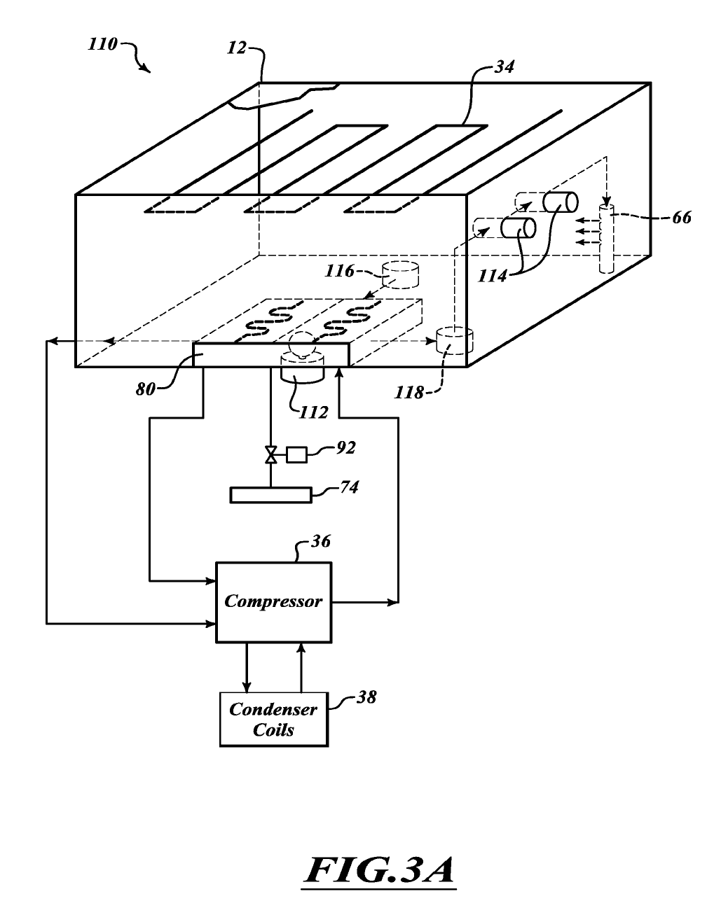

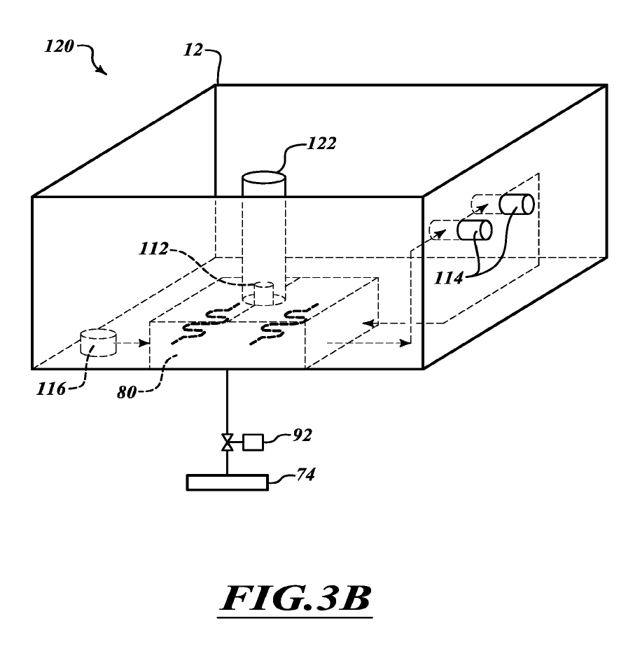

In the embodiment shown in FIG. 3A, the purification system 110 is ozone free and can take the form of one or more LEDs 112 placed outside the tank 12 to treat water as it passes through the heating-cooling unit 80, which have the benefit of longevity without producing heat inside the tank 12, as cool water is preferable in order to minimize bacteria propagation. The LEDs 112 preferably have a wavelength of up to approximately 365 nm in order to effectively kill any bacteria in the water. In one aspect, the wavelength of the LED is in the range up to 365 nm and ideally from 265 nm through 285 nm, and more preferably at 280 nm. The generator tank 12 may also be provided with one or more external filters 114 that can be periodically changed by the user. One filter may be a sediment filter and the other a carbon filter, with the output from the last filter going to the stand pipe 66. Other parts of the system 110, such as the evaporation portion with evaporator coils 34, are similar to that shown in FIG. 1, while the dispensing portion of the system can be internal, as shown in FIG. 2, or may be external, as shown in FIG. 1. In the internal version shown in FIG. 3A, two pumps 116, 118 are used to push and pull water through the unit 80, respectively. The pumps 116, 118 may be coupled to the LED 112 to control operation, e.g., the external LED 112 is energized when the pumps 116, 118 are energized.

FIG. 3B show a system 120 similar to the system 110 of FIG. 3A, except here the LED lamp 112 is positioned inside the tank 12 above the heating-cooling unit 80 and inside a clear tube 122. More particularly the tube 122 is solid and serves only to house the LED lamp 112, which has its beam directed to shine inside the heating-cooling unit 80 where water is pumped through by the pump 116 at a prescribed flow rate to control the bacteria. Filters 114 are mounted in the front wall of the tank 12 so as to be replaceable from the exterior of the tank 12. A single pump 116 is used to move the water in the tank 112 to prevent stagnation and scrub surfaces in the tank 112 that are in contact with the water. In this version the tank can be of a portable size. For example, it can be 10 inches high, 20 inches deep, and 20 inches wide and hold about 5 gallons of water. It includes the evaporator coils and other elements described above necessary to produce the water. The heating-cooling unit 80 is ideally structure to hold about 8 ounces to 16 ounces of water.

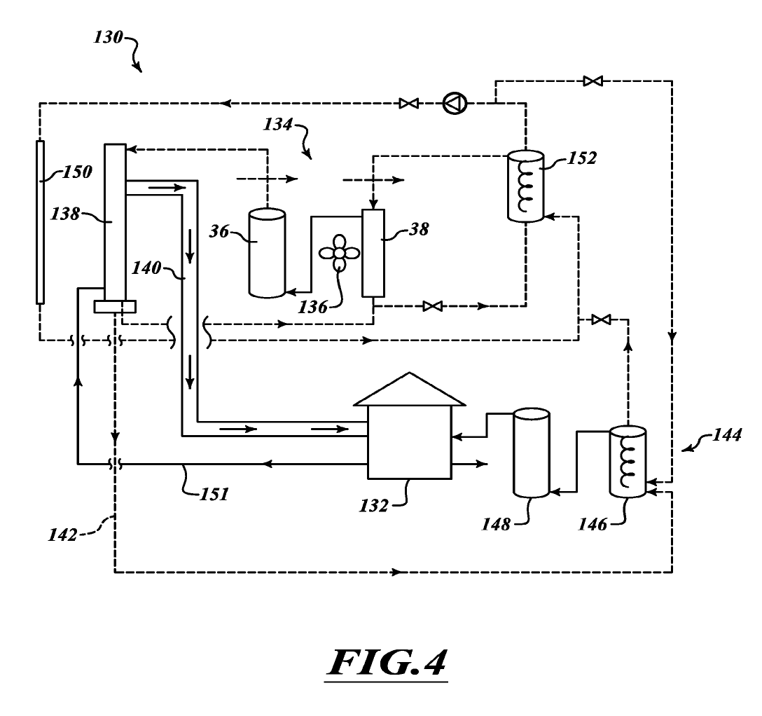

In a further embodiment, best shown in FIG. 4, the atmospheric water generator system 130 can be used on a larger scale, such as an HDACW—Heating Dehumidifying Air-Conditioning and Water system. An atmospheric water generator may be mounted outside of a building 132. Air is pulled into the intake area 134 by a fan 136, passing across one or more condensing members or evaporator coils 138, and creating cooled air 140. The compressor pumps the refrigerant through the condenser 38 as shown in FIG. 4. The cooled air 140 is ducted into the building 132 as air conditioning to cool the building 132. Condensated water 142 can be piped directly into the building 132 to provide a cold water source and be treated by the system described above thereby rendering it potable water. Some or all of the water may instead be piped into a heating area 144, such as through a heat transfer tank 146 and/or a hot water heating/storage tank 148, and then provided to the building as a source of hot water. In one aspect of the disclosure, the water is heated by hot gas or air coming off the compressor 36. The heating area may be provided with heat from the refrigeration circuit or any other available source.

Excess air pressure from ducting the air conditioned air into the building may be vented, or may be ducted back to the atmospheric water generator for further dehumidification via duct 151. If dehumidification is desired, the air may be vented back to the condensing member or coils 138, thereby removing more moisture. The dehumidified air is then ducted back into the building 132, while the collected water joins the rest of the water collected from the initial passage of air through the condensing members 138.

Because the initial air intake is exposed to the atmosphere, ice may tend to form around the intake area as the ambient temperature drops. A preheat coil or membrane 150 may be provided in front of an air intake area to warm the air before it passes across the condensing member 138. The preheat coil or membrane 150 may be heated, for example by collected water, which has passed through a heat transfer area, shown in FIG. 4 as a glycol heat transfer tank 152, to achieve a sufficiently high temperature. The preheat coil or membrane 150 may be operative only once the ambient air temperature drops below a certain point, in order to conserve energy.

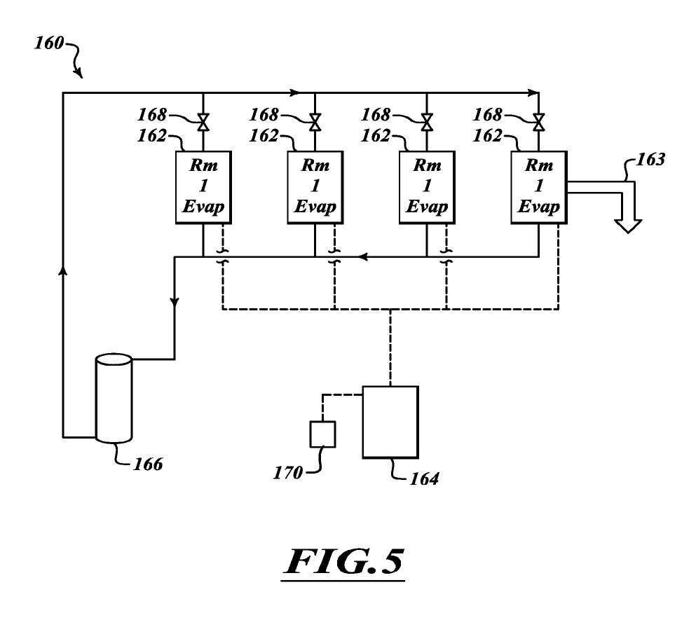

In another embodiment, best shown in FIG. 5, the atmospheric water generator system 160 can be used as a multi-zone applications, such as in two or more rooms of a single family house. In one embodiment, one or more evaporation portions 162 of the atmospheric water generator system are located in one or more zones, which may be one or more connected rooms, to dehumidify the air in each zone, and to provide cool air 163 to each zone. The condenser coils 164 and the compressor 166, which may be any suitable type, such as a variable speed, rotary or reciprocating compressor, are preferably located externally. Cooled air may also be ducted to the outside of the building, if air conditioning is not desired. Valves 168 may be used to control whether the evaporation portion in each zone is operational or not, at any given time. The water produced by the evaporation portion may be collected and piped to the collection portion of the atmospheric water generator system, located in a central location, such as a kitchen, where water is typically in higher demand. Alternatively, the piping arrangement may be such that water is collected at two or more primary locations in the area, such as bathrooms, or to one or more storage tanks in, on or under the building. An overflow tank 170 may be added to collect excess water produced by the evaporation portions, and may contain water level indicators, showing when the overflow tank should be emptied.

Alternatively, a roof top HVAC unit is used to generate condensate water that is purified and fed to a room or purified at a “hydrocenter” in each room of the structure.

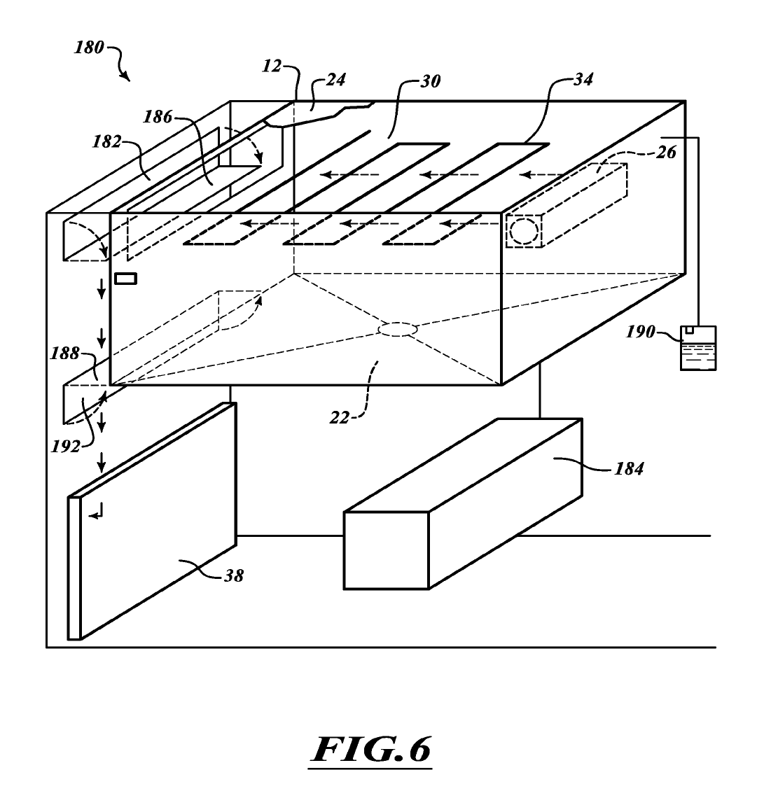

In another embodiment shown in FIG. 6, the atmospheric water generator 180 can be used primarily as an air conditioning unit. In this embodiment, the atmospheric water generator 180 contains similar features as those embodiments in FIGS. 1-3, including the intake fan 26 and water condensing portion 30 of the system and the purification system (not shown), in any suitable form. In order for the atmospheric water generator 180 to operate as an air conditioning unit, an opening 182 is provided across the condensing members from the intake fan 26, in order to simply vent the cooled air directly into the room. A second fan 184 may be provided to cool the interior of a generator housing that contains the tank 12 and the rest of the refrigeration circuit, i.e., the compressor 36 (not shown) and the condenser coil 38.

In order to operate this embodiment as a water generation system, a movable cover 186 is provided to block a first opening 182 in the housing through which the cooled air would otherwise exit after leaving the tank 12. In order to collect water, but not to vent cool air to the room, the flap would cover the opening 182, while a second flap 188 is positioned over a second opening 192 in the housing to allow the cooled air to flow towards and through the condenser coil 38, where it would be warmed before being vented into the room. More particularly, in the water production mode, both flaps or covers 186, 188, are in the vertical position and air passes across the evaporator coil 34, through the condenser coil 38, and the second fan 182 is off. In the air conditioning mode, both flaps 186, 188 are in the horizontal position allowing cool air to exit the first opening 182. The second fan 184 turns on to allow for cooling of the refrigeration circuit. Heat from the first fan 26 is ducted outside through the second opening 192 and cool air from the first opening 182 fills the room. A control system (not shown) for the first and second flaps or covers 186, 188 can be manually implemented or electronically via a computing device, such as a computer system, application specific integrated circuit, or other known electronic control system that is either stand alone or coupled to an intranet or local or global network.

Condensated water may be stored in the generator tank 12 and emptied periodically, or may be collected, purified and dispensed as in any of the above embodiments. A storage or overflow tank 190 may be provided to enable more water to be collected and more air to be cooled before it becomes necessary to empty the tank.

In accordance with another embodiment of the present disclosure, a contact biocide can be used to provide and maintain water purity. This material can provide a non-mechanical way to purify water without the use of UV lights or ozone. Ideally stabilized bromine is used as the contact biocide agent or material. More preferably, the stabilized bromine is presented in the form of a pellet, such as a polystryrene bead that incorporates the bromine to give a controlled release of the bromine into the water. In other words, the bromine migrates to the surface of the bead and kills surrounding bacteria. The beads are replaced when the bromine is depleted. Preferably the water is circulated through this treatment every 4 hours to control bacteria. A GAC filter can be used to scrub the bromine from the water.

In another alternative embodiment, the biocide agent can be coated on the outside of the evaporative coil assembly to reduce the bacteria on the coil assembly.

As will be readily appreciated from the foregoing, the present disclosure provides a variable speed compressor that allows following the dew point and increasing the BTU load as required. The variable speed compressor allows for the InstaCold system that dispenses cold water at the push of a button with minimal time delay at the dispenser or spigot. Moreover, InstaCold and InstaHot can operate in the same chamber. The InstaHot can use the advantages of the variable speed compressor to heat the water as super heated gas is utilized from the main compressor, e.g. 200 degrees Fahrenheit to heat the water, although standard heating and cooling elements can be used as needed. The use of the InstaCold and InstaHot system reduces costs because heating and cooling are provided on demand. A solenoid valve can purge the system daily, or returns the water to the recirculation system.

The variable speed compressor also allows for dehumidifier mode or AC mode as both cycles require different evaporative coil temperatures. It also allows for multi-zone applications or additional zones on one compressor. A water center “Hydro Center” can be developed to be utilized by dishwashers, microwaves, and the like. The Hydro Center can be flush mounted in a cabinet if desired.

Other advantages include the use of desiccant before the corona for a longer life. Ozonated water is bypassed once per day over an internal evaporative coil. A medium pressure UV light can be used to destroy endotoxins, below 240 nm and above 300 nm. A microwave heater can be used to destroy ozone, or hot water from the InstaHot system can be used in the recirculation loop to destroy the ozone. This design will eliminate the need for ozone resistant pumps and other materials, as well as the need for carbon filter vent and downstream filter, because there is no ozone in the tank. The new recirculation design, Hydro Swirl,” eliminates organic and non-organic build up of oxidized materials in the tank. It also eliminates biofilms on the tank internal surfaces. The new tank design allows for sediments and products of ozonation to be gathered to the tank center for filtration.

VaporMax technology allows for additional air scrubbing within the tank because the evaporative coil is inside the main water tank. Coil Clean allows ozonated water or purified water or both to flow over evaporative coils at specified intervals and for re-circulated water to flow over coils, cleaning the cools and cooling the water. It will therefore be appreciated by those skilled in the art that the preferred and alternative embodiments have been described in some detail but that various modifications may be practiced without departing from the principles of the disclosure. For example, the air filter may be either a HEPA filter or a carbon impregnated filter made of paper or other suitable material.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a water condensation unit having a fan and an evaporator coil assembly mounted in an interior of a tank, the evaporator unit structured to draw ambient air into the tank and across the evaporator coil and to generate condensate water on the evaporator coil assembly that falls and collects in the tank;
a purification unit in liquid communication with the interior of the tank, the purification unit having an ozone injector structured to inject ozone into water drawn from the tank, and an ozone filter positioned immediately after the ozone injector and structured to remove ozone from the water exiting the ozone injector, a return line exiting the ozone filter and in liquid communication with the interior of the tank to return the filtered water to the tank, and a distribution system mounted inside the tank and in fluid communication with the return line, the distribution system structured to move the water in the tank to prevent stagnation and to scrub interior surfaces in the tank that are in contact with the water; and
a dispensing unit in liquid communication with the interior of the tank and structured to dispense water outside the tank, the dispensing unit comprising a heating-cooling assembly that is structured to heat or cool the water at the time the water is dispensed from the dispensing unit.

2. The system of claim 1, wherein the water condensation unit comprises at least one diverter mounted in the interior of the tank and adjacent the evaporator coil assembly, the at least one diverter structured to force the air to return over the evaporator coil assembly.

3. The system of claim 2, wherein the diverter has a plurality of openings formed therein to allow a portion of the air passing over the evaporator coil assembly to pass there through without returning over the evaporator coil assembly.

4. The system of claim 1, wherein the purification unit is located outside the tank.

5. The system of claim 1, wherein the purification system comprises an LED light assembly structured to treat the water and convert O₃ in the water into O₂.

6. The system of claim 5, wherein the LED light assembly is mounted inside the tank to reside in the water collected in the tank.

7. The system of claim 1, wherein the heating-cooling assembly is mounted in the interior of the tank.

8. The system of claim 1, wherein the dispensing unit is coupled to the return line to dispense filtered water from the return line.

9. The system of claim 1, further comprising a cleansing assembly having a conduit in liquid communication with the return line and structured to dispense filtered water over the evaporator coil assembly in the interior of the tank.

10. The system of claim 1, comprising a housing containing the tank, a condenser coil, and a vent system having first and second openings in the housing with respective first and second flaps operatively controllable to be selectively opened and closed whereby when both flaps are in an opened position, cool air from the tank exits the first opening and warm air passing over the condenser coil exits the housing through the second opening and when only the first flap is open the cool air exits the housing.

11. The system of claim 10 further comprising a second fan mounted in the housing and structured to direct air across the condenser coil, and when only the first flap is open, the second fan is turned off.

12. The system of claim 1 comprising a plurality of tanks, each tank having an evaporator coil assembly and a fan, each tank mounted in a respective room, and further comprising a single compressor and condenser coil that are coupled to the evaporator coil assembly in each tank.

13. The system of claim 6, wherein the water condensation unit comprises at least one diverter mounted in the interior of the tank and adjacent the evaporator coil assembly, the at least one diverter structured to force the air to return over the evaporator coil assembly, and further comprising a cleansing assembly having a conduit in liquid communication with the return line and structured to dispense filtered water over the evaporator coil assembly in the interior of the tank.

14. The system of claim 1 wherein the distribution system comprises at least one stand pipe mounted in the tank and in fluid communication with the return line to direct water in the tank and cause movement of the water in the tank.

15. The system of claim 14 wherein the stand pipe comprises at least one nozzle.

16. An ozone-free water generation system, comprising:
a water condensation unit having a fan and an evaporator coil assembly mounted in an interior of a tank, the evaporator unit structured to draw ambient air into the tank and across the evaporator coil and to generate condensate water on the evaporator coil assembly that falls and collects in the tank;
a purification unit in liquid communication with the interior of the tank, the purification unit having an LED light structured to purify the water in the tank, and a distribution system mounted inside the tank and structured to move the water in the tank to prevent stagnation and to scrub interior surfaces in the tank that are in contact with the water; and
a dispensing unit in liquid communication with the interior of the tank and structured to dispense water outside the tank, the dispensing unit comprising a heating-cooling assembly that is structured to heat or cool the water at the time the water is dispensed from the dispensing unit.

17. The system of claim 16, wherein the heating-cooling assembly is mounted in the interior of the tank and the LED is structured to purify water in the heating-cooling assembly.

18. The system of claim 16 comprising at least one filter mounted on a wall of the tank and replaceable from outside the tank.
